(19) United States
(12) Patent Application Publication
(10) Pub. No.: US 2016/0060924 A1
(43) Pub. Date: Mar. 3, 2016

(54) Magnetic gate latch

(71) Applicants: Manjit Singh, Jalandhar (IN); Jeewanjot Singh, Jalandhar (IN)

(72) Inventors: Manjit Singh, Jalandhar (IN); Jeewanjot Singh, Jalandhar (IN)

(21) Appl. No.: 14/475,711

(22) Filed: Sep. 3, 2014

(51) Int. Cl. E05C 17/56

(52) U.S. Cl. CPC E05C 17/56

(57) ABSTRACT

A magnetic gate latch opens and secures closed a portal or gate employing improvements that favors continued smooth operation and that minimizes freeze-up during winter. The improvements enable confined movement of the locking pin within a hollow cavity at the bottom of a lifting rod. The locking pin includes a flange extending outward from around the locking pin to divide the locking pin into an upper portion that slides within the hollow cavity and a lower portion that confines a spring. An elliptical aperture in the upper portion surrounds a rivet that limits locking and unlocking movement of the locking pin. The spring pushes up on the flange to bias the locking pin in an upward, unlocked position and hold it there after the gate is opened.

### TECHNICAL FIELD

In the field of closures and fasteners, a magnetic gate latch with improved resistance to seizing due to freezing water and jamming due to component interference.

### BACKGROUND ART

Magnetic gate latches are available as automatic gate closure security. These are typically vertically-installed, self-latching devices for applications involving fences around swimming pools, where it is convenient to both prevent young children from reaching the opening knob to enter a pool area without supervision, yet easily permit taller adults to pull up the knob to open the gate. When the gate re-closes, the magnetic gate latch automatically locks. Opening the gate again requires manual action to raise the knob to again unlock the gate.

Magnetic gate latches typically have a latch pin that is magnetically attracted to a locked position once the gate is closed. An adult person, who is tall enough, then pulls up a knob to also pull up the latch pin to its retracted position, which is held in place by a spring biasing the latch pin in the retracted position once the gate is opened and away from the more powerful draw of the magnet. When the gate is re-closed, the latch pin is automatically re-positioned by the draw from the magnet to the latched position to secure the gate in a closed position.

### SUMMARY OF INVENTION

A magnetic gate latch opens and secures closed a portal or gate. The magnetic gate latch has two primary parts: a main body assembly for vertical attachment to a post adjacent to the gate and a secondary assembly for attachment to the gate. When the gate closes and the two primary parts come in contact, the gate automatically latches when a magnet pulls a locking pin in place.

The main body assembly has a pull knob at its top and a catcher and a locking pin at its bottom. A rod connects the pull knob to the locking pin. The rod has a hollow cavity at the bottom where the locking pin slides in its movement to lock and unlock the gate.

The secondary assembly is attached to the gate and it contains the magnet housing where the permanent magnet is installed to engage the catcher when the gate closes. When the magnet housing strikes against the catcher, the locking pin is drawn out of the main body assembly by the permanent magnet to latch the gate

The locking pin includes a flange extending outward from around the locking pin to divide the locking pin into an upper portion and a lower portion. The upper portion defines an elliptical aperture completely through the locking pin. The lower portion defines a location of a spring surrounding the locking pin. The spring pushes up on the flange to bias the locking pin in an upward direction.

The upper portion of the locking pin fits in and slides within the hollow cavity of the rod. A rivet is located through the rod at the hollow cavity and the rivet traverses through the elliptical aperture in the upper portion of the rod. The rivet thus limits sliding movement of the locking pin to the upper and lower limits of the elliptical aperture within the hollow cavity.

### TECHNICAL PROBLEM

A first problem is that magnetic gate latches often become inoperable during the winter time from water entering the mechanism and thereafter freezing the locking pin in place. The gate cannot thereafter be unlatched until the ice is broken or until the water melts and frees the locking pin. A magnet latch improvement is needed that shields the locking pin from being coated with ice and thus prevents its proper functioning.

A second problem is that magnetic gate latches often become inoperable because the spring acting to bias the locking pin in an unlocked upward position can become non-functional when interfered with by internal lock components. A magnet latch improvement is needed that places the spring in an operable position that will minimize interference from other components of the latch.

### SOLUTION TO PROBLEM

The solution is a magnetic gate latch having a locking pin defining an elliptical aperture. This elliptical cavity is combined with a hollow cavity at the bottom end of the rod. The rod is the physical connection to the locking pin that when lifted up, also pulls the locking pin to an unlocked position. The elliptical aperture in the locking pin is both shielded and confined within the hollow cavity by a fixed rivet that passes through the hollow cavity and the elliptical aperture. The shielding provided by the hollow cavity prevents winter freeze up of the locking pin due from water infiltration.

### ADVANTAGEOUS EFFECTS OF INVENTION

The combination of rivet-limited and water-shielded movement of the locking pin within a hollow cavity of the rod protects the magnet gate latch's functioning by avoiding jamming from water that infiltrates into the latch's main body and freezes in winter. The shielding design of the hollow cavity provides greater assurance that the locking pin will slide in engagement and disengagement of the magnetic gate latch, regardless of the weather conditions.

In addition, the combination of a spring flange on the locking pin and a surrounding spring below the flange enables independent operation of the spring to bias the locking pin in an open position. An independent and smooth functioning of the spring without interfering or disturbing the rest of the device favors a more reliable operation of the magnetic gate latch.

### BRIEF DESCRIPTION OF DRAWINGS

The drawings illustrate preferred embodiments of the magnetic gate latch according to the disclosure. The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a side elevation view of a magnetic gate latch showing components thereof.

FIG. 2 is a perspective of the magnetic gate latch of FIG. 1 with a post bracket added.

FIG. 3 is an elevation view of the pull knob, the rod, and locking pin within the hollow cavity at the bottom of the rod.

FIG. 4 is a side elevation view of the locking pin with an elliptical aperture defined in the upper portion of the locking pin, a flange defining the transition to the lower portion of the locking pin, and a spring surrounding the lower portion of the locking pin.

FIG. 5 is an exploded view of the magnetic gate latch of FIG. 1.

FIG. 6 is a perspective of the main body assembly of the gate latch of FIG. 1

FIG. 7 is a perspective of section 7-7 shown in FIG. 6.

FIG. 8 is a perspective of the secondary assembly of the gate latch of FIG. 1.

FIG. 9 is an exploded view of the secondary assembly of FIG. 8.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made without departing from the scope of the present invention.

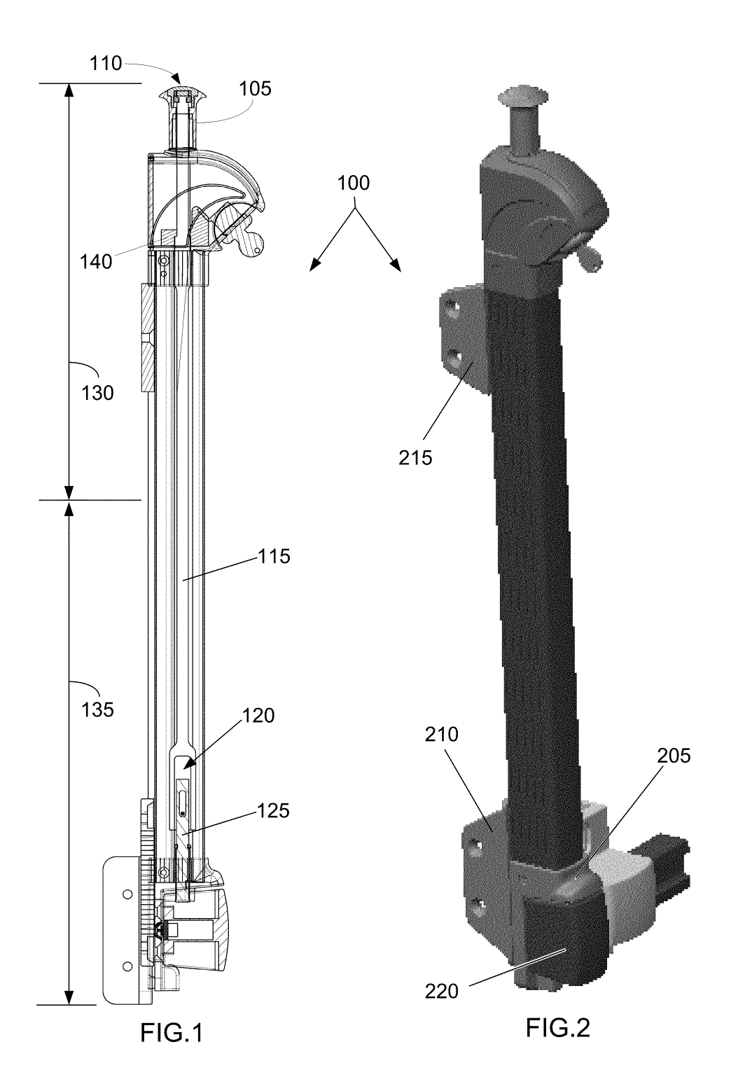

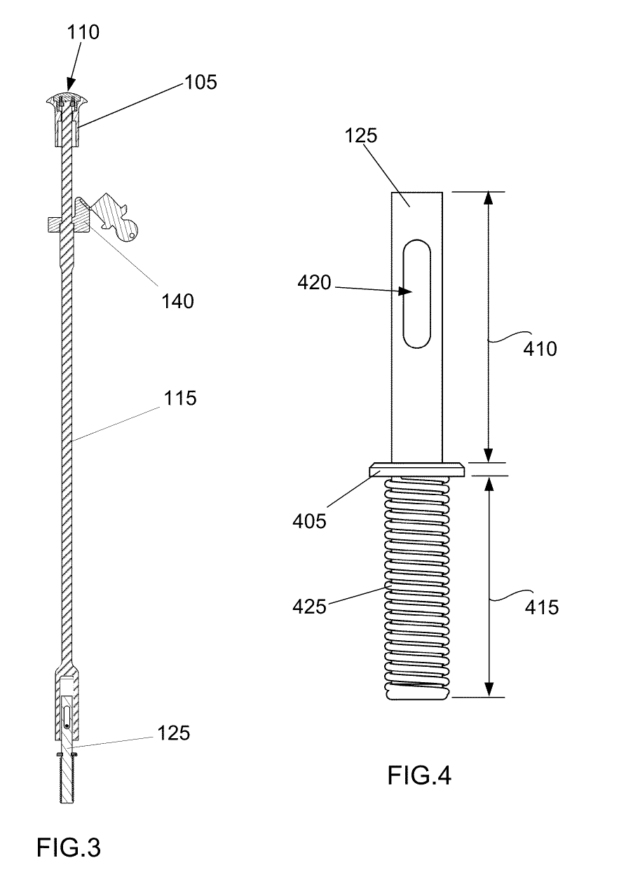

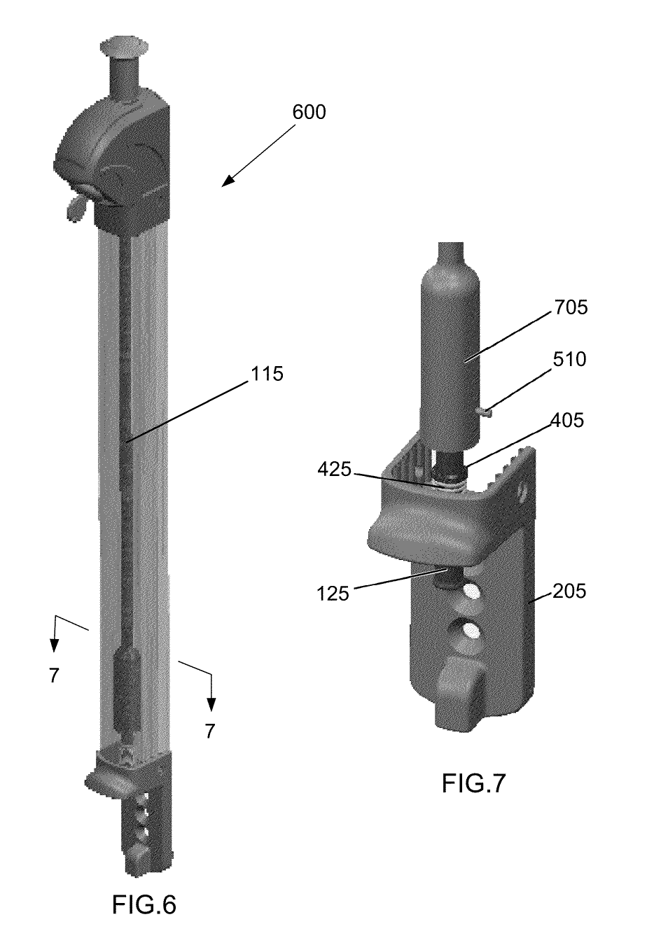

Referring to FIG. 1, FIG. 2 and FIG. 6, a magnetic gate latch (100) is usable to open a gate or portal and to secure its closure. The gate or portal would typically be found as part of a fenced enclosure, such as, for example, around a pool.

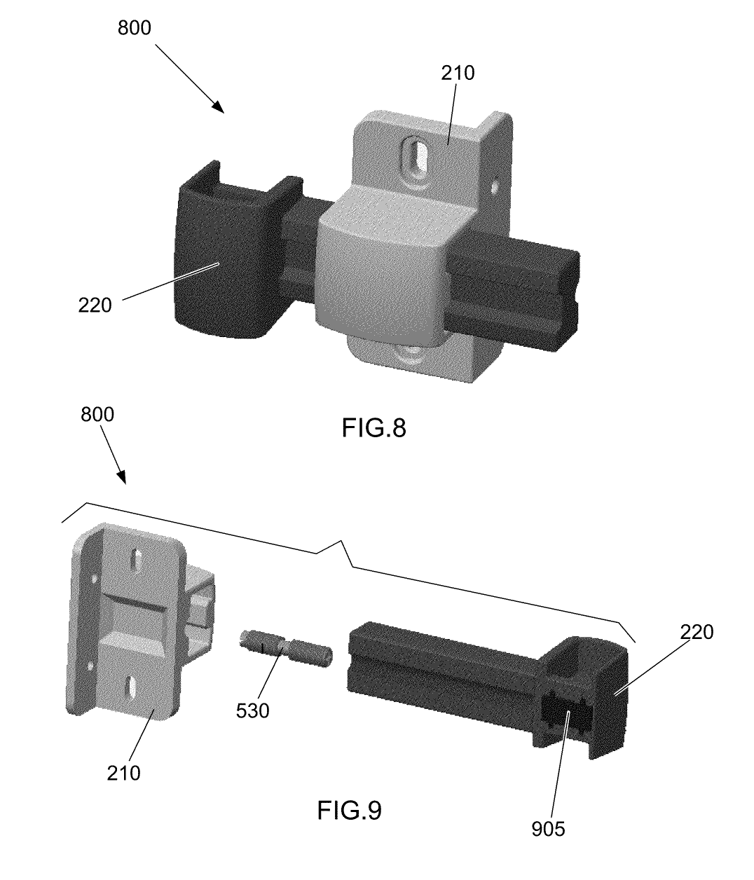

The magnetic gate latch (100) includes a main body assembly (600), shown in FIG. 6, for vertical attachment to a post adjacent to the gate and a secondary assembly (800), shown in FIG. 8, for attachment to the gate. A post bracket (215) secures the main body assembly (600) to the post and a gate bracket (210) secures the secondary assembly (800) to the gate.

The main body assembly (600) includes an upper section (130), a lower section (135) and a rod (115). The upper section (130) generally refers to components in the top half of the magnetic gate latch (100) and the lower section (135) generally refers to components in the bottom half of the magnetic gate latch (100), where the directional descriptors, such as top and bottom, used herein, denote the directions when the magnetic gate latch (100) is installed on the fence post and gate.

The upper section (130) includes a pull knob (105) at a top (110) of the upper section (130). The pull knob (105) is used to raise the rod (115) and thus the locking pin (125) so that the gate can be opened. The lower section (135) includes a catcher (205) and a locking pin (125). The catcher (205) is configured to engage or seat the magnet housing (220) when the gate is closed so that the permanent magnet (905) in the magnet housing (220) can attract the locking pin (125) into a lower position that locks the gate in a closed position.

The rod (115) is connected to the pull knob (105) and extends downward. A portion (705) of the rod (115) at its distal bottom end defines a hollow cavity (120). The hollow cavity (120) is configured to slidably receive therewithin the upper portion (410) of the locking pin (125). The locking pin (125) is preferably able to slide up and down within the hollow cavity (120) so that the locking pin (125) can be drawn downward by the permanent magnet (905) and so that the locking pin (125) can be pulled upward by the pull knob (105) to disengage the locking pin (125) from with the magnet housing (220) when the gate is to be opened.

The hollow cavity (120) is preferably about the same size as the upper portion (410) of locking pin (125), that is, the part of the locking pin (125) above the flange (405). The flange (405) defines the uppermost position of the spring (425) on the locking pin (125). The spring (425) surrounds the lower portion (415) of the locking pin (125) and biases the locking pin (125) to the upward, unlocked position but is not strong enough to prevent the permanent magnet (905) from pulling the locking pin (125) downward to a locking position when the gate is closed and the magnet housing (220) is immediately below the locking pin (125). Preferably, the only opening in the hollow cavity (120) accessible by water is a bottom-facing hole where the locking pin (125) exits the hollow cavity (120).

The main body assembly (600) also preferably includes: a cover (515) over the rod (115) to keep out water and dust; a cam lock (520), which is key operated to preclude upward movement of the pull knob (105) by rotation of a L-type locking part (140) into a notch in the rod (115) so as to prevent opening the magnetic gate latch (100) and the gate; a lock housing (525) and a lock housing back cover (555) to cover the cam lock (520); a magnet cover (545) to close in the permanent magnet (905) within the magnet housing (220); and a gap adjuster (530) for adjusting the fit of the magnet housing (220) in the catcher (205).

The secondary assembly (800) includes the permanent magnet (905) within a magnet housing (220) that engages the catcher (205), as shown in FIG. 2, when the gate closes such that when the magnet housing (220) strikes against the catcher (205), the locking pin (125) is drawn out of the main body assembly (600) by the permanent magnet (905) to latch the gate.

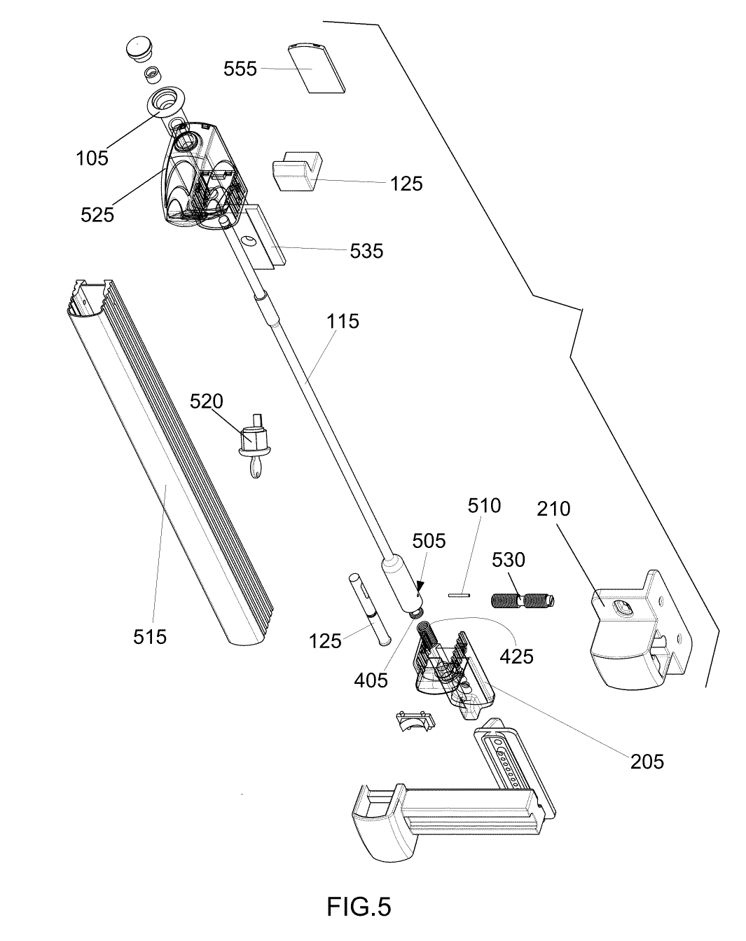

The locking pin (125), as shown in FIG. 1 and FIG. 4, includes a flange (405) extending outward from around the locking pin (125) to divide the locking pin (125) into an upper portion (410) and a lower portion (415).

The upper portion (410) defines an elliptical aperture (420). The elliptical aperture (420) is used to confine the movement of the locking pin (125). When assembled, the locking pin (125) is inserted into the hollow cavity (120). A rivet (510), also described as a pin or a bar, is then inserted through a rivet hole (505) that more or less horizontally pierces the portion (705) of the rod (115) with the hollow cavity (120). This is most easily understood by referencing FIG. 5.

The rivet (510) also transits through the elliptical aperture (420) on the locking pin (125) so that once fixed in place through the portion (705) of the rod (115), the rivet (510) stops and confines the relatively unburdened movement of the locking pin (125) between the upper part of the elliptical aperture (420) and the lower part of the elliptical aperture (420).

The elliptical aperture (420) essentially provides a means for confined movement of the locking pin (125) without having also to move the rod (115). Thus, the rod (115) defines a rivet hole (505) through the portion (705) of the rod (115) defining the hollow cavity (120) and the magnetic gate latch (100) further includes a rivet (510) extending through the rivet hole (505) and through the elliptical aperture (420) of the locking pin (125). Once installed, the rivet (510) preferably seals the rivet hole (505) against the flow of water into the hollow cavity (120).

The lower portion (415) of the locking pin (125) defines a location of a spring (425) surrounding the locking pin (125). The spring (425) is limited in upward position by the flange (405) so that the spring (425) acts on the flange (405) to bias the locking pin (125) in an upward direction. The bias from the spring (425) is not strong enough to resist the downward pull of the permanent magnet (905) that draws the locking pin (125) to a position that holds the main body assembly (600) and the secondary assembly (800) together and locks the gate in a closed position.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the closures and fasteners industry.

What is claimed is:

1. A magnetic gate latch to open and secure closed a portal or gate, the magnetic gate latch comprising:
a main body assembly for vertical attachment to a post adjacent to the gate, the main body assembly comprising:
an upper section comprising a pull knob at a top of the upper section;
and a lower section comprising a catcher and a locking pin; and
a rod connected to the pull knob, the rod extending downward so that a portion of the rod defines a hollow cavity;
a secondary assembly for attachment to the gate, the secondary assembly comprising:
a permanent magnet within a magnet housing that engages the catcher when the gate closes such that when the magnet housing strikes against the catcher, the locking pin is drawn out of the main body assembly by the permanent magnet to latch the gate; and
a gate bracket that secures the secondary assembly to the gate;
wherein the locking pin comprises:
a flange extending outward from around the locking pin to divide the locking pin into an upper portion and a lower portion, wherein:
the upper portion defines an elliptical aperture; and
the lower portion defines a location of a spring surrounding the locking pin, the spring acting on the flange to bias the locking pin in an upward direction;
wherein the hollow cavity is configured to slidably receive therewithin the upper portion of the locking pin;
wherein the rod further defines a rivet hole through the portion of the rod defining the hollow cavity; and
wherein the magnetic latch further comprises a rivet extending through the rivet hole and through the elliptical aperture of the locking pin.
